(19) United States
(12) Patent Application Publication
(10) Pub. No.: US 2003/0003891 A1
(43) Pub. Date: Jan. 2, 2003

(54) Method to improve I/Q-amplitude balance and receiver quadrature channel performance

(75) Inventors: Kalle Kivekas, Espoo (FI); Jarkko Jussila, Helsinki (FI); Aarno Parssinen, Espoo (FI)

Correspondence Address: COHEN, PONTANI, LIEBERMAN & PAVANE, Suite 1210, 551 Fifth Avenue, New York, NY, 10176, US

(73) Assignee: Nokia Corporation

(21) Appl. No.: 09/897,249

(22) Filed: Jul. 2, 2001

(51) Int. Cl. H04B 1/26

(52) U.S. Cl. 455/313; 455/323; 455/324

(57) ABSTRACT

The invention relates to a quadrature demodulating radio receiver and to a method for reducing an imbalance in gain between an in-phase channel and a quadrature channel of such a radio receiver. Received radio frequency signals are downconverted to in-phase and quadrature-phase signals, either to a baseband or a certain IF frequency. In order to improve the performance of the channels, it is proposed that imbalances in gain or amplitude between the two channels are compensated in the analog domain. This is achieved by employing in at least one of the channels amplifying means with an adjustable gain for amplifying received signals in the analog domain, the adjustable gain being controlled according to a detected imbalance in gain. The invention moreover relates to an equivalently designed radio transmitter and a corresponding method. The invention equally relates to components and communications systems including such a radio receiver or transmitter, and to a transconductance mixer for such a radio receiver or transmitter.

### BACKGROUND OF THE INVENTION

1. Field of the Invention

The invention relates to a radio receiver for demodulating quadrature (IQ) modulated radio frequency signals, and to a corresponding radio transmitter. The invention moreover relates to a transconductance mixer for such a radio receiver or transmitter, and to a base station, a mobile station and a radio communications system comprising such a radio receiver or transmitter. The invention equally relates to a method for reducing an IQ gain imbalance.

2. Description of the Related Art

Radio receivers are known from the state of the art, for example for receiving radio frequency signals in mobile stations or base stations of a radio communications system, which radio frequency signals were transmitted by some radio transmitter of the radio communications system.

If a quadrature modulation is employed in a communications system for transmitting signals, a radio transmitter modulates the in-phase (I) and the quadrature-phase (Q) signal components of local oscillator signals that are phase offset by 90 degrees. The two modulated carrier signals are then superposed for transmission. For quadrature demodulation, the radio receiver then has to provide two separate channels. The modulated signal is downconverted/demodulated using signals provided by a local oscillator that are again 90 degrees phase shifted to each other to produce either quadrature baseband or quadrature IF (intermediate frequency) signals.

For illustration, a block diagram of a conventional direct conversion radio receiver is depicted in FIG. 5.

In this radio receiver, a receiving antenna 1 is connected via a bandpass filter 2 to a low-noise amplifier (LNA) 3. The output of the LNA 3 is connected on the one hand to an I-channel 4 of the radio receiver and on the other hand to a Q-channel 5 of the radio receiver, both channels being referred to also simply as quadrature channels. In both quadrature channels 4, 5, a mixer 40, 50, a channel selection filter 41, 51, a variable gain amplifier (VGA) 42, 52 and an analog-to-digital (A/D) converter 43, 53 are cascaded. The outputs of both channels 4, 5 are connected to digital signal processing units which are not shown in FIG. 5. A local oscillator 6 is further connected to the mixer 40 in the I-channel 4 and via a 90° phase shifter 7 to the mixer 50 in the Q-channel 5 of the radio receiver.

Radio frequency signals are received via the receiving antenna 1. The received signals are then bandpass filtered by the bandpass filter 2 and amplified by the LNA 3 before being fed in parallel to both, I-channel 4 and Q-channel 5 of the radio receiver.

In each of the two quadrature channels 4, 5, the signals are first processed by the respective mixer 40, 50, in order to obtain the in-phase and the quadrature component of the received signal by mixing it with a suitable high frequency signal. In the mixer 40 of the I-channel 4, the received signal is mixed for downconversion with a high frequency signal received directly from the local oscillator 6, the output of the mixer 40 constituting the in-phase component of the received signal. In the mixer 50 of the Q-channel 5, the received signal is mixed for downconversion with the high frequency signal received from the local oscillator 6 via the 90° phase shifter 7, the output of this mixer 50 thus constituting the quadrature component of a signal.

In both quadrature channels 4, 5, the signals output by the respective mixer 40, 50 pass the respective channel selection filter 41, 51, by which a desired channel is filtered out. Subsequently, the selected channel is amplified in both channels 4, 5 with an adjustable gain by the respective VGA 42, 52 and converted into a digital signal by the respective analog-to-digital converter 43, 53. The output of both analog-to-digital converters 43, 53 is then fed to the digital signal processor for further processing in the digital domain.

Since the original signal is processed on two separate channels 4, 5 for regaining the in-phase and the quadrature component, a different gain may be applied by the respective channel 4, 5 to the signal. In case the demodulation is carried out at radio frequency, usually most of the gain imbalance result from the mixers 40, 50, since devices used at high frequencies cannot be implemented to match as well as those used at baseband frequencies. The problem of gain imbalance occurs also with integrated radio receivers, even though integrated components can be realized with lower tolerances that match in principle very well.

In known digital receivers, I/Q gain imbalance is compensated only if needed in the digital back-end after the analog signal processing.

The effects due to the mismatch between the two quadrature channels is particularly severe in receivers which employ a non-zero intermediate frequency after quadrature downconversion because of the high image rejection requirements (IRR) for such receivers. However, a large error between the channels can also cause problems in a direct conversion architecture. In direct conversion receivers, the intermediate frequency is zero, and thus there is no image frequency. However, some image rejection is still required due to the overlap of the signal sidebands in the downconversion process.

Error might occur, when the typically high noise from the active channel selection filters becomes “visible” in one of the quadrature channels after a gain drop in the respective other quadrature channel.

Noise figure is a number used to characterize the quality of a circuit or a channel. It tells the decrease in signal to noise ratios between the input and output in decibels. Imbalance in the noise figures between the channels reshape the constellation of the received signal and thus deteriorate the Bit-Error-Rate (BER). If the required receiver noise figure is low, there is typically not much headroom for additional performance tolerances. Even a small gain mismatch can increase the noise figure of one of the quadrature channels. In a properly implemented integrated circuit, the gain error between the two quadrature channels is typically about 0.5 dB without compensation.

This problem cannot be solved with digital signal processing by compensating for a gain imbalance after the noise figure of one of the quadrature channels has been increased too much.

Similar problems may occur in a radio transmitter.

### SUMMARY OF THE INVENTION

It is an object of the invention to enable a reduction of gain imbalances between the I- and the Q-channel of a radio receiver employing IQ demodulation and of a radio transmitter employing IQ modulation.

It is also an object of the invention to improve the performance on the quadrature channels of a radio receiver employing IQ demodulation and of a radio transmitter employing IQ modulation.

On the one hand, a radio receiver comprising an I-channel and a Q-channel is proposed, said channels being provided in parallel at a respective input with quadrature modulated radio frequency signals. In the I-channel, a first mixer is arranged. The mixer includes a switching/multiplying stage for downconverting a radio frequency signal fed to said in-phase channel to an in-phase component of the signal. A switching/multiplying stage is suited to perform a downconversion of radio frequency signals to an IF or to a baseband. In the quadrature channel, a second mixer is arranged. The second mixer includes a switching/multiplying stage for downconverting the radio frequency signal fed to said quadrature channel to a quadrature component of the signal. In addition, amplifying means are arranged in at least one of said I-channel and said Q-channel for amplifying signals in the analog domain with an adjustable gain. Detecting means are further employed in the radio receiver for detecting an imbalance in gain between at least part of said in-phase channel, said part including said first mixer, and of a corresponding part of said quadrature channel, said corresponding part including said second mixer. Finally, the proposed radio receiver comprises controlling means for controlling the adjustable gain of said amplifying means in a way that a detected imbalance in gain is reduced.

Equally proposed are a mobile station for a radio communications system, a base station for a radio communications system and a radio communications system including such a radio receiver.

Moreover, a transconductance mixer for a radio receiver is proposed comprising the amplifying means for amplifying radio frequency signals with an adjustable gain, means for downconverting radio frequency signals amplified by said amplifying means, and controlling means for controlling said adjustable gain according to the proposed radio receiver.

Further, a corresponding method for reducing an imbalance in gain between the I- and Q-channels of a quadrature demodulating radio receiver is proposed. The method comprises in a first step feeding quadrature modulated radio frequency signals in parallel to said I-channel and to said Q-channel of said radio receiver. Then, the radio frequency signals are downconverted to an in-phase component of the received signal in the I-channel and to a quadrature component of the received signal in the Q-channel. Before or after downconversion, the signals are amplified in the analog domain in at least one of said I- and said Q-channels with an adjustable gain. The proposed method further includes determining whether there exists currently an imbalance in gain between at least a part of said in-phase channel and a corresponding part of said quadrature channel, which parts respectively include the downconversion of radio frequency signals. The adjustable gain with which signals are amplified at least in one of the in-phase and the quadrature channels can then be controlled in a way that a detected imbalance in gain is reduced.

On the other hand, a radio transmitter is proposed. The radio transmitter comprises an I-channel to an input of which in-phase components of a signal are fed and a Q-channel to an input of which quadrature-phase components of said signal are fed. A first mixer is arranged in the I-channel, which first mixer comprises a switching/multiplying stage for upconverting received in-phase components of signals to a radio frequency signal. A second mixer is arranged in the Q-channel, which second mixer comprises a switching/multiplying stage for upconverting received quadrature-phase components of signals to a radio frequency signal. The radio transmitter further includes amplifying means arranged in at least one of the I-channel and the Q-channel for amplifying signals in the analog domain with an adjustable gain. Detecting means are employed for detecting an imbalance in gain between at least part of the I-channel, said part including the first mixer, and of a corresponding part of the Q-channel, said corresponding part including the second mixer. Finally, controlling means are provided for controlling the gain of the amplifying means in a way that detected imbalances in gain are reduced.

As for the radio receiver, also for the radio transmitter a corresponding transconductance mixer, a corresponding mobile station, a corresponding base station, a corresponding communications network, and a corresponding method are proposed.

The invention proceeds from the idea that gain or amplitude imbalances between the I- and the Q-channels of a radio receiver or transmitter can be compensated in the analog domain. The compensation is achieved for the radio receiver by controlling the adjustable gain of amplifying means arranged in at least one of the two channels before means employed for converting the signals into the digital domain. The compensation is achieved for the radio transmitter by controlling the adjustable gain of amplifying means arranged in at least one of the two channels after means for converting the components into the analog domain. With such methods, such a radio receiver and such a radio transmitter, a sufficient gain balance can be achieved and the IRR and Error Vector Magnitude (EVM) of the radio receiver or transmitter can be improved.

Preferred embodiments of the radio transmitter and the method for modulation of the invention correspond to the preferred embodiments of the radio receiver and the method for demodulation of the invention. Therefore, only preferred embodiments of the radio receiver of the invention will be mentioned in detail.

In a first preferred embodiment of a radio receiver, the amplifying means are arranged between the input and the mixer of at least one of the I- and the Q-channel for amplifying received radio frequency signals already before downconversion with an adjustable gain. When adjusting the signals' amplitudes already before downconversion, it is possible to avoid imbalance in the noise figures of the two channels and to use a larger part of the dynamic range of the mixers and the analog-to-digital converters.

The employed mixers are preferably transconductance mixers comprising in a first stage amplifying means and in a second stage downconversion means. The amplifying means of at least one of the transconductance mixers can then constitute the adjustable amplifying means provided in at least one of the quadrature channels.

In a further preferred embodiment, adjustable amplifying means are provided in both channels before downconversion. Thus not only the gain in one of the I- or the Q-channel is adjustable by the controlling means, but both. The controlling means then advantageously always compensate detected gain imbalance by adjusting the adjustable gain of the amplifying means in the channel which currently has the lower gain, since typically, the signal in the channel with the lower gain has the higher noise figure. Thereby, not only a gain imbalance and a noise figure degradation is avoided, but additionally, the noise figure of the entire receiver can be enhanced equal to the noise figure of the better one of the two quadrature channels.

Amplifying means with an adjustable gain in both channels can be realized most easily by using in both channels transconductance mixers with separately adjustable amplifying means in the respective first stage.

In a further preferred embodiment of the invention, transconductance mixers realized as an integrated component are used as mixers. Such transconductance mixers can be realized in particular as integrated component including also the controlling means of the radio receiver of the invention. Advantageously, at least one of the amplifying means of the integrated transconductance mixers are then digitally controlled via the integrated controlling means. The entire radio receiver might be designed as integrated radio receiver. It equally is possible, though, to use discrete components and to control the amplifying means analogously.

The adjustable amplifying means employed in one or both of the quadrature channels can for example comprise at least one transistor for amplification. The gain of the adjustable amplifying means is then controllable by adjusting the bias current of the transistor of said amplifying means. In one possible alternative, many amplifying elements are provided in one channel, which elements can be switched on/off separately in order to obtain a desired total gain. The amplifying element can be e.g. many parallel selectable (on/off) transconductance stages instead of one transconductance stage in a transconductance mixer.

The detection of an imbalance of gain can be carried out either by analog or digital signal processing methods. In the analog domain, the detecting means can comprise in particular a power or a Vrms (Voltage root mean square) detector which detects the power of signals in both channels at some point after the respective downconversion. In the digital domain, the downconverted signals are evaluated for an imbalance in gain after being converted from analog into digital signals. The evaluation can be carried out by some common digital signal processing means.

The controlling means can be realized as a current digital to analog converter (IDAC). Such an IDAC can be employed in particular for controlling the bias current of transistors used as adjustable amplifying means.

The invention can be used in any image rejection architecture. It is of particular relevance for radio receivers that require a high image rejection ratio, e.g. a direct conversion radio receivers or radio receivers with quadrature branches at some intermediate frequency.

The radio receiver can be either a pure radio receiver or a combined radio receiver/transmitter and be integrated in any suitable device. Such devices may be hand sets, radio links or low-cost base stations like pico base stations. The invention can be used for example, though not exclusively, for WCDMA base station applications.

In particular in a low noise figure direct conversion radio receiver in which the downconversion and analog baseband produce a significant amount of the total noise, an improvement of the noise figure and thus the dynamic performance can be achieved with the invention.

Even though some preferred embodiments of the invention were presented, the invention is not restricted to these embodiments, but comprises any suitable other embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference numerals delineate similar elements throughout the several views:

FIG. 1 is a block diagram of a first embodiment of a radio receiver of the invention;

FIG. 2 is a block diagram of a second embodiment of a radio receiver of the invention;

FIG. 3 schematically shows an embodiment of transconductance mixers of the invention;

FIG. 4 schematically shows an embodiment of controlling means of a radio receiver of the invention; and

FIG. 5 is a block diagram of a conventional direct conversion receiver.

### DETAILED DESCRIPTION OF THE PRESENTLY PREFERRED EMBODIMENTS

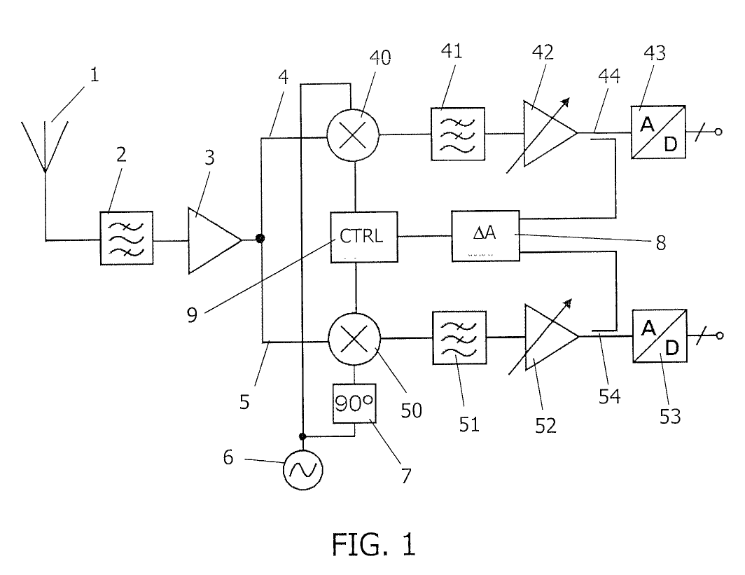

A first embodiment of a radio receiver of the invention is illustrated by the block diagram of FIG. 1. The block diagram represents an integrated direct conversion receiver that could be employed for example for WCDMA base station applications. In this first embodiment, the detection of an IQ gain imbalance is based on an analog signal processing.

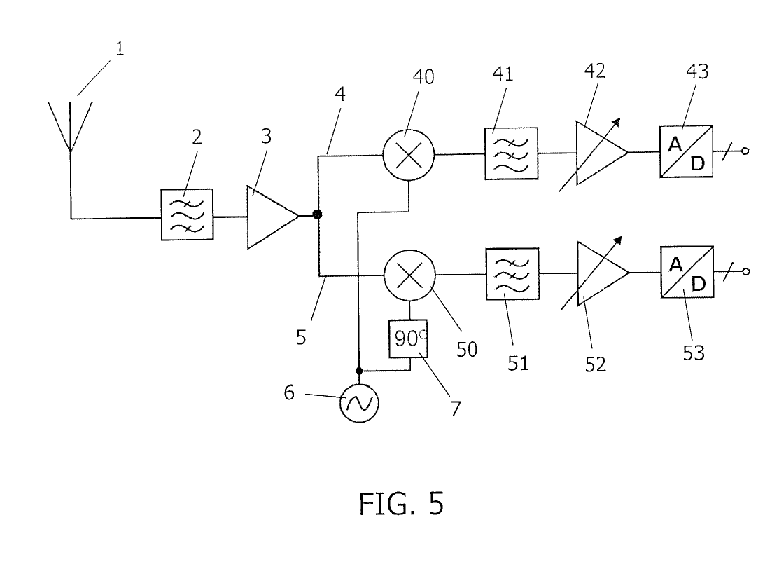

The structure of the radio receiver corresponds to the structure of the receiver described with reference to FIG. 5, wherein the mixers 40, 50 of FIG. 5 are assumed to be transconductance mixers. Transconductance mixers are composed of two processing stages. In a first stage, a signal is received, converted from voltage mode to current mode, and amplified. Only in a second stage, the amplified signal is downconverted to an in-phase and a quadrature component of the received signal by mixing it with a suitable high frequency signal as described above.

The structure of FIG. 5 is further supplemented in FIG. 1 with features of the invention. Only these supplemented features and their functions will be dealt with explicitly at this place.

The output of the variable gain amplifiers 42, 52 of the I-channel 4 and the Q-channel 5 of the radio receiver are coupled by coupling means 44, 54 to a common power detector 8. The output of the power detector 8 in turn is connected to the input of controlling means 9, which controlling means 9 have a controlling access to the transconductance mixers 40, 50 in both quadrature channels 4, 5, and more specifically, to the amplifiers of the first stage of the transconductance mixers 40, 50.

Signals received via the receiving antenna 1 are processed by the radio receiver of FIG. 1 just like signals received via the receiving antenna 1 are processed by the radio receiver of FIG. 5.

A part of the signals leaving the respective variable gain amplifier 42, 52 of both quadrature channels 4, 5 is coupled by the coupling means 44, 54 to the power detector 8 with the same coupling factor. The power detector 8 determines the gain difference ΔA between the signals received via the coupling means 44 associated to the I-channel 4 and the signals received via the coupling means 54 associated to the Q-channel 5 of the radio receiver. Preferably, the noise power spectrum densities of the quadrature channels are compared in order to determine the gain difference ΔA. That difference is equivalent to the respective amount of imbalance of gain between the two quadrature channels 4, 5, since the power of the signals input to each channel 4, 5 is the same. Based on the determined gain difference ΔA, the power detector 8 generates a digital signal indicative of the value by which the adjustable gain applied by the amplifier of the first stage of one of the transconductance mixers 40, 50 to received signals should be changed, in order to decrease the imbalance of gains. For determining the gain imbalance, a separate test signal or a received radio channel might be used.

The power detector 8 provides the generated signal to the controlling means 9. According to the digital input received from the power detector 8, the controlling means 9 then adjust the gain of the amplifier of the first stage of one of the transconductance mixers 40, 50. As consequence, the received signals are amplified by the transconductance mixers 40, 50 in a way that leads to an essentially equal gain on both of the quadrature channels 4, 5 between the input to the respective channel 4, 5 and the input to the respective analog-to-digital converter 43, 53.

It can be always the amplifier of the same transconductance mixer 40, 50 that is adjusted by the controlling means 9 in an appropriate direction by an appropriate value. Then only the gain of this amplifier has to be adjustable. Alternatively, however, the amplifier of the first stage of both transconductance mixers 40, 50 is adjustable, and it is always the amplifier of the transconductance mixer 40, 50 in the channel 4, 5 with the currently lower gain that is adjusted. As a result of the second alternative, in addition to the balanced gain a reliably reduced overall noise figure can be achieved.

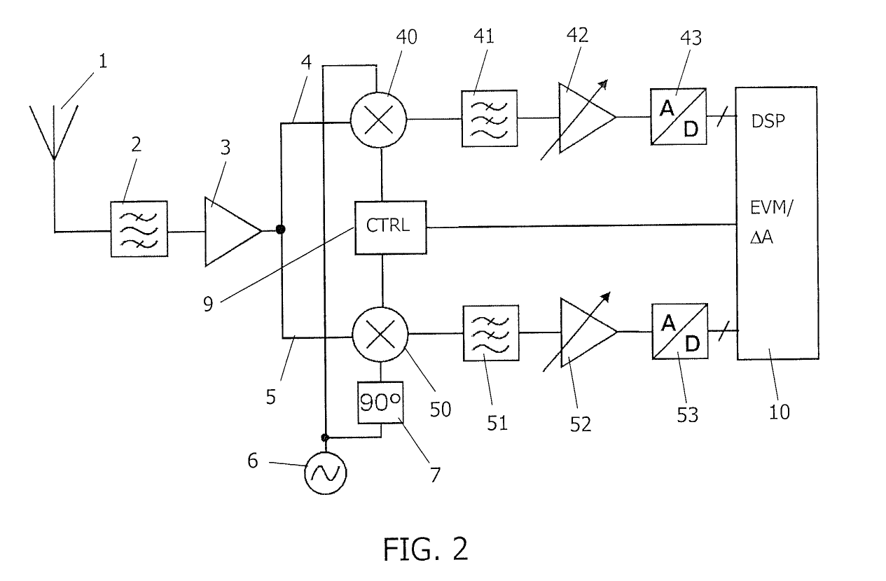

The block diagram of FIG. 2 illustrates a second embodiment of the radio receiver of the invention, in which the detection of gain imbalance is based on digital signal processing methods. The radio receiver includes again all elements 1 to 7, 40 to 43 and 50 to 53 described with reference to FIG. 5. Moreover, a digital signal processor or processing unit DSP 10 is shown, to which the outputs of both channels 4 and 5, of the radio receiver are connected. In addition to output terminals not shown, the digital signal processor 10 comprises an output connected to controlling means 9. Like in FIG. 1, the controlling means 9 have a controlling access to the amplifier in the respective first stage of the transconductance mixers 40, 50 in both channels 4, 5.

As in the first embodiment of the radio receiver of the invention, also in the second embodiment depicted in FIG. 2 signals received via the receiving antenna 1 are processed like signals received by the radio receiver of FIG. 5.

In this case, however, there are no signals coupled out in the analog domain for determining a power difference as in the embodiment of FIG. 1. Instead, a gain imbalance is determined based on the digital signals in the digital signal processor 10 to which the digital signals are fed. In the digital domain, the calibration can be done via the symbol constellations, even during the reception. The gain difference ΔA between the signals leaving the I- and Q-channels 4 and 5 of the analog radio receiver can be determined for example by using EVM information. The gain difference ΔA is again indicative of the respective gain imbalance between the quadrature channels 4, 5.

The digital signal processor 10 forwards control signals to the controlling means 9 that were determined based on the current imbalance of gain. As in the embodiment of FIG. 1, the controlling means 9 then adjust the amplifier of the first stage of one of the transconductance mixers 40, 50, in order to reduce the imbalance of gain detected in the digital signal processing means 10.

Also the radio receiver of the embodiment of FIG. 2 can be an integrated radio receiver and be employed for example for WCDMA base station applications.

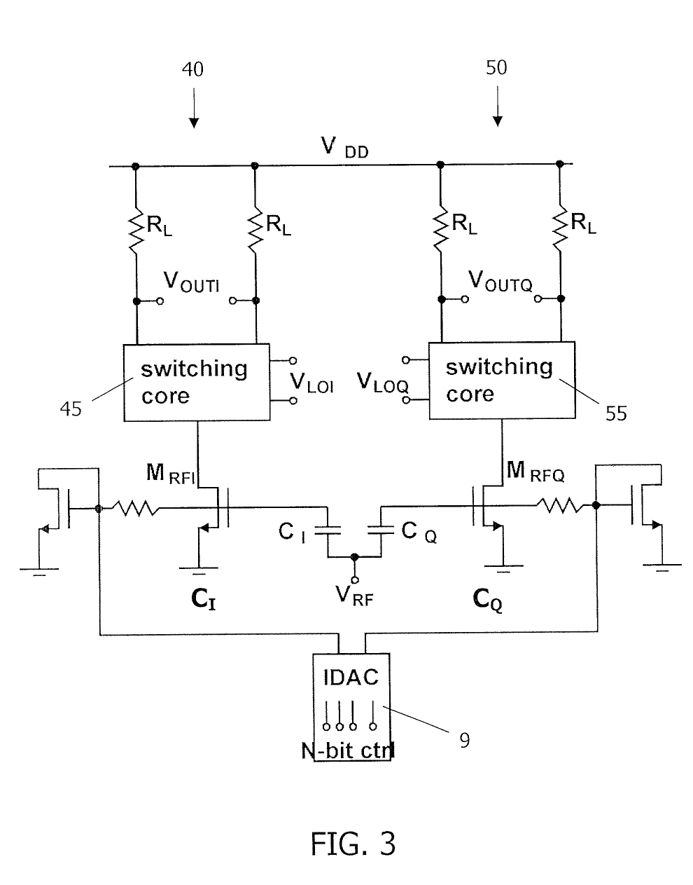

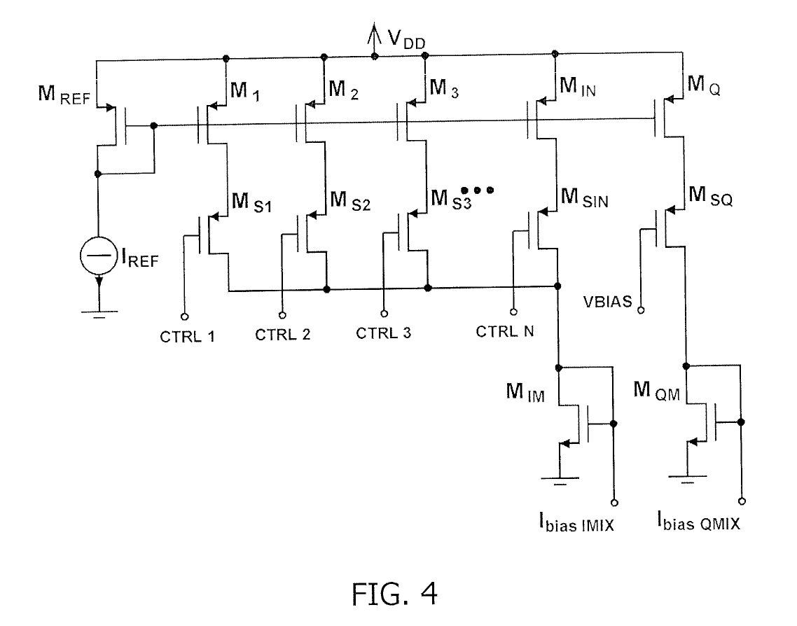

The controlling of the amplifiers in the first stage of the transconductance mixers 40, 50 in both quadrature channels 4, 5 will now be described in more detail with reference to FIGS. 3 and 4.

FIG. 3 schematically shows an embodiment of the transconductance mixers 40, 50 and the controlling means 9 of FIG. 1 or 2. Both mixers have an identical structure.

Each mixer 40, 50 has a common input terminal V_{RF} that is connected to the output of the common low-noise amplifier 3 of FIG. 1 or 2, which connections are not shown in FIG. 3. In each mixer 40, 50, the input terminal V_{RF} is connected via a capacitor C_{I}, C_{Q} to the gate of an input MOS transistor M_{RFI}, M_{RFQ}. The respective gate of the input transistors M_{RFI}, M_{RFQ} are further connected in parallel to outputs of a single current digital-to-analog converter IDAC 9. The IDAC 9 is employed in this embodiment as the controlling means 9 of FIG. 1 or 2 and has a digital N-bit control input N-bit ctrl.

The drains of the input transistors M_{RFI}, M_{RFQ} of the transconductance mixers 40, 50 are connected to a respective switching core 45, 55 indicated in the Figure only as a block. Each switching core 45, 55 has further input terminals V_{LOI}, V_{LOQ} for a connection to a local oscillator 6. The input terminal V_{LOI} of the switching core 45 of the transconductance mixer 40 in the I-channel 4 is connected directly to the local oscillator 6, while the input terminal V_{LOQ} of the switching core 55 of the transconductance mixer 50 in the Q-channel 5 is connected to the local oscillator 6 via the 90° phase shifter 7, as indicated in FIGS. 1 and 2.

Each switching core 45, 55 has a pair of output terminals V_{OUTI}, V_{OUTQ}, which provide a voltage tap connected to the respective channel selection filter 41, 51 of FIG. 1 or 2. Each of the four output terminals is further connected via a separate resistor R_{L} to a common power supply not shown.

The transconductance mixers 40, 50 are able to perform the functions described above with reference to FIG. 5. A signal received by the radio receiver of FIG. 1 or 2 is forwarded after bandpass filtering and amplification in parallel as input signal V_{RF} to the in-phase and the quadrature transconductance mixer 40, 50. In each mixer 40, 50 the input voltage is converted into a current by the respective capacitor C_{I}, C_{Q} and applied to the gate of the respective input transistor M_{RFI}, M_{RFQ}. Corresponding to this current, an amplified current signal is fed by the input transistors M_{RFI}, M_{RFQ} to the respective switching core 45, 55. The amplification given by the transistors M_{RFI}, M_{RFQ} depends on the respective bias current determined by the IDAC 9. In the switching cores 45, 55, the respective current signal is downconverted by mixing it with the signal V_{LOI}, V_{LOQ} provided by the local oscillator 6 directly and via the 90° phase shifter 7 respectively. The downconverted signal V_{OUTI}, V_{OURQ} is then provided to the channel selection filter 41, 51 of the respective quadrature channel 4, 5 and further processed as described with reference to FIG. 1 or 2.

The voltage conversion gain A_{V}—of the transconductance mixers 40, 50 in FIG. 3 is proportional to the transconductance gₘ of the input transistors M_{RFI} and M_{RFQ}.

In a quadrature downconverter, the total gain error between the I- and the Q-channel 4, 5 can be reduced by changing the gain of one of the channels 4, 5. In this embodiment of the invention, the gain of at least one of the channels 4, 5 is changed in radio frequency, i.e. before downconversion of the received signal. In a particularly simple implementation, the transconductance gₘ of the input transistors M_{RFI}, M_{RFQ} of the mixers 40, 50 is controlled. To this end, a fixed current can bias the input transistor M_{RFQ} of one mixer 50, while the input transistor M_{RFI} of the other mixer 40 is biased using an adjustable bias current. The bias current applied to a transistor influences the respective transistor channel current I_{D} and is thus able to change the transconductance gₘ.

In the embodiment of FIG. 3, the input transistors M_{RFI}, M_{RFQ} of both mixers 40, 50 are biased by a current digital-to-analog converter 9. Initially, both bias currents are equal. Then, according to the gain imbalance detected between the I- and Q-channels 4, 5, the bias current is increased or decreased to either increase or decrease the voltage conversion gain A_{V} of the mixer 40 in the I-channel 4 until the balance level is determined by the detecting means 8 of FIG. 1 or the digital signal processor 10 of FIG. 2 to be acceptable. The designed adjustment range should be wide enough to cover the worst-case amplitude error with the desired resolution.

FIG. 4 schematically shows an embodiment of the IDAC 9 employed in FIG. 3 as the controlling means of FIG. 1 or 2. The IDAC of FIG. 4 is designed to provide a fixed current via one of its outputs I_{bias QMIX} to the gate of the transistor M_{RFQ} of the transconductance mixer 50 in the Q-channel 5 of the radio receiver. In addition, a digitally adjustable current is provided at the second of its outputs I_{bias IMIX} to the gate of the transistor M_{RFI} of the transconductance mixer 40 in the I-channel 4 of the radio receiver.

In the IDAC, a voltage supply V_{DD} is connected via a cascode connection of two CMOS transistors M_{Q}, M_{SQ} to a first current output I_{bias QMIX}. The voltage supply V_{DD} is further connected in parallel via N series connections of two CMOS transistors M₁-M_{N}, M_{S1}-M_{SN} respectively to a second current output I_{bias IMIX}. The respective second transistors M_{S1}-M_{SIN} are cascode devices to respective current sources. The connection between the second transistor M_{SQ} of the cascode connection of transistors M_{Q}, M_{SQ} associated to the first current output I_{bias QMIX} and the first current output I_{bias QMIX} is in addition connected to drain and gate of a NMOS transistor M_{QM}, the source of which is grounded. Equally, the connection between the second transistors M_{S1}-M_{SIN} of the N parallel cascode connections and the second current output I_{bias IMIX} is in addition connected to drain and gate of another NMOS transistor M_{QM}, M_{IM}, the source of which is also grounded.

The voltage supply V_{DD} is moreover connected via a reference CMOS transistor M_{REF} to a reference current source I_{REF}. The connection between the reference transistor M_{REF} and the current source I_{REF} is connected to the gate of each of the first transistors M_{Q}, M₁-M_{IN} in the N+1 series of transistors and equally to the gate of the reference transistor M_{REF}. All these transistors M_{REF}, M_{Q}, M₁-M_{IN} are thus provided with the same bias current.

The gate of the second transistor M_{SQ} of the cascode connection of transistors M_{Q}, M_{SQ} associated to the first current output I_{bias QMIX} is connected to a bias voltage input VBIAS of the IDAC 9. The bias current I_{BIAS,QMIX} applied to the transistor M_{RFQ} of FIG. 3 belonging to the transconductance mixer 50 of the Q-channel 5 is thus fixed by providing a constant bias current VBIAS to transistor M_{SQ}.

Each gate of the second transistors M_{S1}-M_{SIN} of the N parallel cascode connections of transistors M₁-M_{IN}, M_{S1}-M_{SIN} is connected to a dedicated digitally controlled input CTRL1-CTRLN. The digitally controlled input CTRL1-CTRLN corresponds to the input N-bit ctrl of the IDAC 9 depicted in FIG. 3. The bias current I_{BIAS,IMIX} applied to the transistor M_{RFI} of FIG. 3 belonging to the transconductance mixer 40 of the I-channel 4 can therefore be adjusted by applying control signals to the transistors M_{S1}-M_{SIN} of FIG. 4. Control signals are provided at the inputs CTRL1-CTRLN e.g. by the detecting means 8 of FIG. 1 or the digital signal processor 10 of FIG. 2. The value of the control signals depends on the detected gain imbalance and therefore on the presently required change of gain of the in-phase transconductance mixer 40 of FIG. 3.

A proper solution is achieved by enabling an increase in the controlling current I_{bias IMIX} as powers of two. The IDAC of FIG. 4 therefore employs binary-weighted unit current sources for biasing the adjustable mixer 40 of the embodiment of FIG. 3. More specifically, transistors M₁ and M_{ref} are both LSB (least significant bit) current sources having equal dimensions. The other transistors M₂-M_{IN} are binary weighted current sources.

The cascode transistors M_{S1}-M_{SIN} are binary weighted corresponding to the weighting of the transistors M₁-M_{IN}. Selected gates of the cascode transistors M_{S1}-M_{SIN} are switched with the respective control signal CTRL 1 to CTRL N to the same bias-voltage as the bias voltage VBIAS applied to the gate of transistor M_{SQ}, in order to feed the required bias current to transistor M_{RFI} of the in-phase mixer 40.

The adjustable bias current I_{BIAS,IMIX} then depends on the applied control voltages CTRL 1 to CTRL N selected by the power detector 8 of FIG. 1 or the digital signal processor 10 of FIG. 2 according to the currently desired bias current I_{BIAS,IMIX} for the adjustable transistor M_{RFI}. The bias current I_{bias QMIX} supplied to the transistor M_{RFQ} of the quadrature mixer 50, in contrast, is fixed.

The tuning resolution of the IDAC 9 can be increased by using more bits, i.e. by increasing the number N of parallel cascode connections of transistors M₁-M_{IN}, M_{S1}-M_{SIN}. As the number of bits is increased, the reference current I_{REF} must be decreased to establish smaller unit current sources. The resolution can also be enhanced by using a smaller aspect ratio between the MOS transistor M_{RFI} and its NMOS current mirror device M_{IM}. In the latter case, however, the range of the transconductance gₘ variation is decreased.

While the IDAC of FIG. 4 is realized as CMOS transistor implementation, the presented invention is not technology dependent. Therefore, also bipolar technology may be employed, for example.

In a further embodiment of the invention, which is not further illustrated by a Figure, both amplifiers of the first stage of the two transconductance mixers 40, 50 of FIGS. 1 or 2 are adjustable by controlling means 9. In FIG. 3, e.g., this means that the bias current of the transistors M_{RFI}, M_{RFQ} of both transconductance mixers 40, 50 can be increased or decreased separately from a nominal value. Typically, the quadrature channel 4, 5 with the lower detected gain has also the worse noise performance. Therefore, by adjusting always the radio frequency amplifier M_{RFI}, M_{RFQ} of the channel 4, 5 with the lower gain, also the noise figure and thus the quadrature channel performance of the radio receiver can be improved.

The radio receivers of the presented embodiments can be varied in any suitable manner without leaving the scope of the invention, as long as the gain in at least one of the IQ-channels can be adjusted in the analog domain according to a detected imbalance in gain or amplitude. In particular, it is not required to control the downconversion means digitally, and neither to adjust the gain of one or both of the channels 4, 5 already in the radio frequency domain.

A radio transmitter according to the invention can be realized for example equivalently to the radio receiver of FIG. 1, but also here many variations are possible as long as the gain in at least one of the IQ-channels can be adjusted in the analog domain according to a detected imbalance in gain or amplitude.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A radio receiver comprising:
an in-phase channel and a quadrature channel, said channels being provided in parallel at a respective input with quadrature modulated radio frequency signals;
a first mixer arranged in said in-phase channel, said first mixer comprising a switching/multiplying stage for downconverting a radio frequency signal fed to said in-phase channel to an in-phase component of said radio frequency signal;
a second mixer arranged in said quadrature channel, said second mixer comprising a switching/multiplying stage for downconverting a radio frequency signal fed to said quadrature channel to a quadrature component of said radio frequency signal;
amplifying means arranged in at least one of said in-phase channel and said quadrature channel for amplifying signals in the analog domain with an adjustable gain;
detecting means for detecting an imbalance in gain between at least part of said in-phase channel, said part including said first mixer, and of a corresponding part of said quadrature channel, said corresponding part including said second mixer; and
controlling means for controlling the gain of said amplifying means in a way that detected imbalances in gain are reduced.

2. The radio receiver of claim 1, wherein said amplifying means are arranged between the input and the switching/multiplying stage of the mixer of at least one of said in-phase channel and said quadrature channel for amplifying radio frequency signals with an adjustable gain.

3. The radio receiver of claim 1, wherein first amplifying means are arranged in said in-phase channel for amplifying signals with an adjustable gain, wherein second amplifying means are arranged in said quadrature channel for amplifying radio frequency signals with an adjustable gain, and wherein said controlling means are suited for adjusting always the adjustable gain of the amplifying means in said in-phase or said quadrature channel, for which channel said detecting means currently detect the lower gain.

4. The radio receiver of claim 1, which radio receiver is a radio receiver processing other than baseband signals in said in-phase and quadrature channels.

5. The radio receiver of claim 1, wherein said mixers are transconductance mixers including amplifying means, and wherein the amplifying means arranged in at least one of said in-phase and said quadrature channel are formed by the amplifying means of at least one of said transconductance mixers.

6. The radio receiver of claim 1, wherein said mixers are realized as integrated transconductance mixers.

7. The radio receiver of claim 1, wherein said mixers are realized as digitally controlled transconductance mixers.

8. The radio receiver of claim 1, wherein said amplifying means comprise at least one transistor for amplification, and wherein the gain of said amplifying means is controllable by adjusting the bias current of said at least one transistor of said amplifying means.

9. The radio receiver of claim 1, wherein said amplifying means comprise at least two amplification means in at least one of said in-phase and said quadrature channel, each of which at least two amplification means can be switched on and off separately for adjusting the total gain of the respective channel.

10. The radio receiver of claim 1, wherein said controlling means are a current digital to analog converter (IDAC).

11. The radio receiver of claim 1, wherein said detecting means comprise a power detector for determining a gain imbalance between parts of said in-phase channel and said quadrature channel, said power detector detecting the power of the downconverted signals in the in-phase and the quadrature channel in the analog domain.

12. The radio receiver of claim 1, wherein said detecting means comprise a voltage root mean square (VRMS) detector for determining a gain imbalance between parts of said in-phase channel and said quadrature channel, said VRMS detector detecting the VRMS of the downconverted signals in the in-phase and the quadrature channel in the analog domain.

13. The radio receiver of claim 1, further comprising in both, said in-phase and said quadrature channel, an analog-to-digital converter for converting the respectively downconverted signals into the digital domain, and a common digital signal processor to which the digital signals of said in-phase and said quadrature channel are forwarded, which digital signal processor is employed as detecting means for detecting a gain imbalance between the in-phase and the quadrature channel in the digital domain.

14. A transconductance mixer for a radio receiver comprising amplifying means for amplifying radio frequency signals with an adjustable gain, means for downconverting radio frequency signals amplified by said amplifying means, and controlling means for controlling said adjustable gain according to claim 1.

15. A mobile station for a radio communications system comprising a radio receiver according to claim 1.

16. A base station for a radio communications system comprising a radio receiver according to claim 1.

17. A radio communications system comprising at least one radio receiver according to claim 1.

18. A method for reducing an imbalance in gain between an in-phase channel and a quadrature channel of a quadrature demodulating radio receiver, the method comprising:
feeding quadrature modulated radio frequency signals in parallel to said in-phase channel and to said quadrature channel of said radio receiver;
downconverting said radio frequency signals to an in-phase component of said radio frequency signal in the in-phase channel and to a quadrature component of said radio frequency signal in the quadrature channel;
amplifying signals in at least one of said in-phase and said quadrature channels in the analog domain with an adjustable gain before or after downconversion;
determining whether there exists an imbalance in gain between at least a part of said in-phase channel and a corresponding part of said quadrature channel, which parts respectively include the downconversion of radio frequency signals; and
controlling the adjustable gain with which signals are amplified in at least one of said in-phase and said quadrature channels in a way that a detected imbalance in gain is reduced.

19. The method according to claim 18, wherein the signals are amplified with said adjustable gain in at least one of said in-phase and said quadrature channels before being downconverted.

20. The method according to claim 18, wherein signals are amplified in both, the in-phase and the quadrature channel, with an adjustable gain, and wherein for reducing a detected imbalance in gain between the in-phase and the quadrature channel always the adjustable gain in the channel is adjusted, for which channel currently a lower gain is detected.

21. The method according to claim 18, wherein the adjustable gain is digitally controlled by a current digital-to-analog converter (IDAC).

22. The method according to claim 18, wherein the imbalance in gain is detected in the analog domain.

23. The method according to claim 18, wherein the imbalance in gain is detected in the digital domain after an analog-to-digital conversion of the downconverted signals.

24. The method according to claim 18, wherein signals are amplified in at least one of said in-phase and said quadrature channels with an adjustable gain by a transistor, the gain of said transistor being controllable by adjusting the bias current of said transistor.

25. A radio transmitter comprising:
an in-phase channel to an input of which in-phase components of a signal are fed;
a quadrature channel to an input of which quadrature-phase components of said signal are fed;
a first mixer arranged in said in-phase channel, said first mixer comprising a switching/multiplying stage for upconverting received in-phase components of signals to a radio frequency signal;
a second mixer arranged in said quadrature channel, said second mixer comprising a switching/multiplying stage for upconverting received quadrature-phase components of signals to a radio frequency signal;
amplifying means arranged in at least one of said in-phase channel and said quadrature channel for amplifying signals in the analog domain with an adjustable gain;
detecting means for detecting an imbalance in gain between at least part of said in-phase channel, said part including said first mixer, and of a corresponding part of said quadrature channel, said corresponding part including said second mixer; and
controlling means for controlling the gain of said amplifying means in a way that detected imbalances in gain are reduced.

26. The radio transmitter of claim 25, wherein said amplifying means are arranged after the output of the switching/multiplying stage of the mixer of at least one of said in-phase channel and said quadrature channel for amplifying radio frequency signals with an adjustable gain.

27. The radio transmitter of claim 25, wherein first amplifying means are arranged in said in-phase channel for amplifying signals with an adjustable gain, wherein second amplifying means are arranged in said quadrature channel for amplifying radio frequency signals with an adjustable gain, and wherein said controlling means are suited for adjusting always the adjustable gain of the amplifying means in said in-phase or said quadrature channel, for which channel said detecting means currently detect the lower gain.

28. The radio transmitter of claim 25, wherein said mixers are transconductance mixers including amplifying means, and wherein the amplifying means arranged in at least one of said in-phase and said quadrature channel are formed by the amplifying means of at least one of said transconductance mixers.

29. The radio transmitter of claim 25, wherein said mixers are realized as integrated transconductance mixers.

30. The radio transmitter of claim 25, wherein said mixers are realized as digitally controlled transconductance mixers.

31. The radio transmitter of claim 25, wherein said amplifying means comprise at least one transistor for amplification, and wherein the gain of said amplifying means is controllable by adjusting the bias current of said at least one transistor of said amplifying means.

32. The radio transmitter of claim 25, wherein said amplifying means comprise at least two amplification means in at least one of said in-phase and said quadrature channel, each of which at least two amplification means can be switched on and off separately for adjusting the total gain of the respective channel.

33. The radio transmitter of claim 25, wherein said controlling means are a current digital to analog converter (IDAC).

34. The radio transmitter of claim 25, wherein said detecting means comprise a power detector for determining a gain imbalance between parts of said in-phase channel and said quadrature channel, said power detector detecting the power of the upconverted signals.

35. The radio transmitter of claim 25, wherein said detecting means comprise a voltage root mean square (VRMS) detector for determining a gain imbalance between parts of said in-phase channel and said quadrature channel, said VRMS detector detecting the VRMS of the upconverted signals in the in-phase and the quadrature channel in the analog domain.

36. A transconductance mixer for a radio transmitter comprising amplifying means for amplifying radio frequency signals with an adjustable gain, means for upconverting radio frequency signals amplified by said amplifying means, and controlling means for controlling said adjustable gain according to claim 25.

37. A mobile station for a radio communications system comprising a radio transmitter according to claim 25.

38. A base station for a radio communications system comprising a radio transmitter according to claim 25.

39. A radio communications system comprising at least one radio transmitter according to claim 25.

40. A method for reducing an imbalance in gain between an in-phase channel and a quadrature channel of a quadrature modulating radio transmitter, the method comprising:
feeding an in-phase component of a signal to said in-phase channel and a quadrature-phase component of said signal to said quadrature channel of said radio transmitter;
upconverting the in-phase component of said signal to a radio frequency signal in said in-phase channel, and upconverting the quadrature component of said signal to a radio frequency signal in said quadrature channel;
amplifying signals in at least one of said in-phase and said quadrature channels in the analog domain with an adjustable gain before or after upconversion;
determining whether there exists an imbalance in gain between at least a part of said in-phase channel and a corresponding part of said quadrature channel, which parts respectively include the upconversion of radio frequency signals; and
controlling the adjustable gain with which signals are amplified in at least one of said in-phase and said quadrature channels in a way that a detected imbalance in gain is reduced.

41. The method according to claim 40, wherein signals are amplified with said adjustable gain in at least one of said in-phase and said quadrature channels after being upconverted.

42. The method according to claim 40, wherein signals are amplified in both, the in-phase and the quadrature channel, with an adjustable gain, and wherein for reducing a detected imbalance in gain between the in-phase and the quadrature channel always the adjustable gain in the channel is adjusted, for which channel currently a lower gain is detected.

43. The method according to claim 40, wherein the adjustable gain is digitally controlled by a current digital-to-analog converter (IDAC).

44. The method according to claim 40, wherein signals are amplified in at least one of said in-phase and said quadrature channels with an adjustable gain by a transistor, the gain of said transistor being controllable by adjusting the bias current of said transistor.
